(19) United States
(12) Patent Application Publication
(10) Pub. No.: US 2018/0204156 A1
(43) Pub. Date: Jul. 19, 2018

(54) COMPUTER ARCHITECTURE FOR STANDARDIZING TASKS

(71) Applicant: Nest International, Inc., Gloucester City, NJ (US)

(72) Inventor: Robert Oliver, Swedesboro, NJ (US)

(21) Appl. No.: 15/408,573

(22) Filed: Jan. 18, 2017

(51) Int. Cl. G06Q 10/06; G06Q 10/08; G06F 3/0482

(52) U.S. Cl. CPC G06Q 10/06311; G06F 3/0482; G06Q 10/087

(57) ABSTRACT

Aspects of the invention include a computer architecture having a location database, a product database, a graphical user interface, and a server. The location database having a location identifier field and property parameter fields configured to store physical property parameters. A product database having a product identifier field and associated product information fields corresponding to the plurality of products. The graphical user interface for presenting to a user and for receiving selections of a product and physical locations. The server is configured to receive the product selection and the physical location selections and determine a scope factor. The scope factor is determined by identifying location identifiers, retrieving physical property parameters, and aggregating the retrieved physical property parameters. The server is configured to retrieve the product information, generate a scoped task by combining the scope factor with the product information, and assign the scoped task to at least one service provider.

### FIELD OF THE INVENTION

The present invention is directed to a computer architecture, and more particularly, a computer architecture for assigning standardized tasks.

### BACKGROUND OF THE INVENTION

Traditionally, large companies that routinely assign tasks to service providers do so through various individuals who contact individual service providers to obtain various items of information. The individuals review the various items of information provided by the service providers and decide which service provider to assign the task. This method, however, provides little standardization for the assigned tasks. Moreover, this method is time consuming and, thus, requires significant human resources to perform.

Accordingly, there is a long felt need for computer architecture for assigning tasks, and more particularly, for computer architecture for standardizing and assigning tasks.

### SUMMARY OF THE INVENTION

Aspects of the invention include computer architectures for assigning tasks to service providers. In accordance with one aspect of the invention, the computer architecture includes a location database for a plurality of users, a product database for a plurality of products, a graphical user interface, and a server.

The location database includes location information for a plurality of users, with each user having one or more physical locations. The location database has a location identifier field configured to store a location identifier corresponding to each physical location and property parameter fields associated with the location identifiers configured to store physical property parameters.

The product database has a product identifier field configured to store a product identifier. The product database also has associated product information fields configured to store product information corresponding to each of the plurality of product.

The graphical user interface is configured to be presented to a user over a network. The graphical user interface is configured to receive a selection of a product from the plurality of products and selections from the plurality of physical locations.

The server is configured to serve the graphical user interface to the user over the network, receive the product selection and the physical location selections, and determine a scope factor. The scope factor is determined by identifying the location identifiers corresponding to the selected physical locations, retrieving the physical property parameters from the property parameter fields associated with the identified location identifiers, and aggregating the retrieved physical property parameters. The server is further configured to retrieve the product information associated with the selected product from the product database, generate a scoped task by combining the scope factor with the product information, and assign the scoped task to at least one service provider.

### BRIEF DESCRIPTION OF THE DRAWINGS

The invention is best understood from the following detailed description when read in connection with the accompanying drawings, with like elements having the same reference numerals. In accordance with common practice, the various features of the drawings are not drawn to scale unless otherwise indicated. On the contrary, the dimensions of the various features may be expanded or reduced for clarity. Included in the drawings are the following figures:

FIG. 1 is a block diagram of a computer architecture in accordance with aspects of the invention;

FIG. 2 is a flow chart depicting an embodiment of a process employed by the server of FIG. 1; and

FIG. 3 is a schematic illustration of the computer architecture of FIG. 1.

### DETAILED DESCRIPTION OF EMBODIMENTS OF THE INVENTION

Aspects of the present invention include computer architectures for assigning tasks to service providers. Using the computer architectures disclosed herein, standardized tasks may be produced and assigned to one or more service providers. As used herein, service providers includes any individual or entity that provides a service, product, or facilitates the completion of a task. The term product, as used herein, refers to any product and/or service requested by the user and/or offered by a service provider.

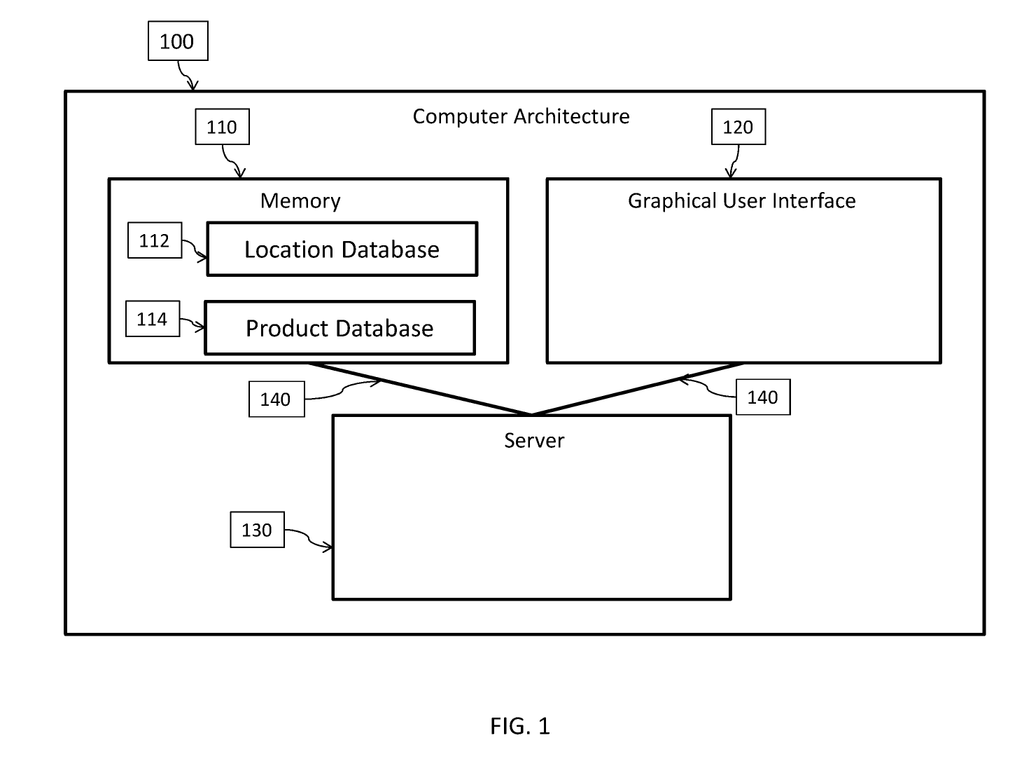

FIG. 1 depicts a computer architecture 100 that includes a memory 110, a graphical user interface 120, and a server 130 in accordance with aspects of the invention.

The memory 110 is configured to store information relating to a location database 112 and a product database 114. Exemplary, non-limiting memory devices include read-only memory (“ROM”), such as programmable ROM, erasable programmable ROM, electrically erasable programmable ROM, Flash, etc., and random-access memory (“RAM”), such as static RAM, dynamic RAM, etc. One of skill in the art would readily recognize suitable devices or apparatuses for memory 110 based on the disclosure provided herein.

The location database 112 includes location information for a plurality of users. Each user may have one or more physical locations, with each location having one or more physical parameters. The physical locations may be geographical locations, such as shopping areas, buildings, outdoor locations, undeveloped areas, etc. The location database 112 may utilize a location identifier field configured to store a location identifier corresponding to each physical location.

In one embodiment, each location identifier corresponds to a single physical location. In another embodiment, a single location identifier corresponds to a plurality of physical locations. Additionally, the location database 112 may include property parameter fields associated with the location identifiers configured to store physical property parameters. Thus, a location identifier may retrieve one or more physical locations and/or one or more physical property parameters associated with the retrieved physical locations. The retrieved physical property parameters may be associated with a single physical location or a plurality of physical locations. For instance, a plurality of physical locations may be cataloged into groups of physical locations, with each group of physical locations having one or more associated physical property parameters that are common to all the physical locations in the group of physical locations. The physical locations may be cataloged into groups based on, e.g., having an identical or substantially similar floor layout, store plan, architectural/structural design, or the like.

The product database 114 is configured to store a plurality of products. The product database 114 may utilize a product identifier field configured for storing a product identifier. Additionally, the product database 114 may utilize associated product information fields for storing product information corresponding to each of the plurality of product. For example, one or more of the plurality of products and the product information associated with the retrieved products may be retrieved using the product information field. The product database 114 may also be configured to catalog one or more of the plurality of products into groups, e.g., based on similar product information, the category of the products, and/or the characteristics of the product. The category of a product is an associated generic or higher-level concept for the product (e.g., an office desk may be within the category of a table). The characteristics associated with a product may include functional aspects of the product or the intended use of the product. Additionally or alternatively, the product database 114 may be configured to catalog one or more of the plurality of products into groups based on a user's preference. For example, the product database 114 may be configured to retrieve products that the user previously identified and/or selected.

The graphical user interface 120 is configured for presentation to a user over a network 140. Graphical user interface 120 is configured to receive selections and/or inputs and present outputs. For example, computer architecture 100 of FIG. 1 includes graphical user interface 120, which is configured to receive a selection of one or more products from the plurality of products and a selection of one or more physical locations from the plurality of physical locations. The graphical user interface 120 may also be configured to receive a temporal selection and/or a quantity section relating to the amount/number of products desired by the user. The temporal selection may relate to the length of time for the completion of an assigned task or may relate to a length of time by which an assigned task is to be periodically repeated (e.g., the assigned task is to be repeated every one week, two weeks, one month, three months, one year, etc.). The graphical user interface 120 may also receive additional inputs, such as notes provided by the user relating to the scope of the task, instructions for completing the task, desired parameters relating to the selected product or product information, etc.

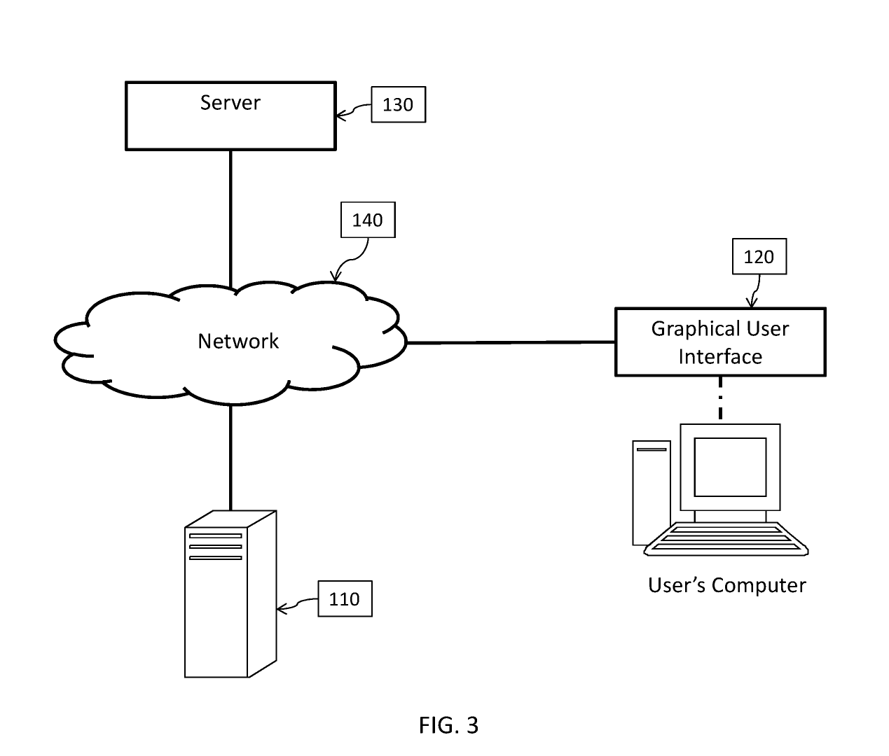

As illustrated in FIG. 3, graphical user interface 120 may present outputs to and/or receive inputs from the user's computer, tablet, phone, or the like. One of ordinary skill in the art would recognize that the graphical user interface 120 may be configured to receive additional inputs and present additional outputs, including those relating to various aspects of standardizing and assigning tasks based on the disclosure provided herein.

The server 130 may include one or more devices or apparatuses for accepting inputs and/or providing outputs or otherwise managing the memory 110 and/or the graphical user interface 120. One of skill in the art would readily recognize suitable devices or apparatuses for server 130 and understand how to configure and operate the server 130 in view of the disclosure provided herein.

As illustrated in FIGS. 1 and 3, the memory 110, graphical user interface 120, and the server 130 may be connected by a network 140. Network 140 may include internal and/or external connections (e.g., land connections, wireless connections, etc.). In one embodiment, network 140 includes the Internet.

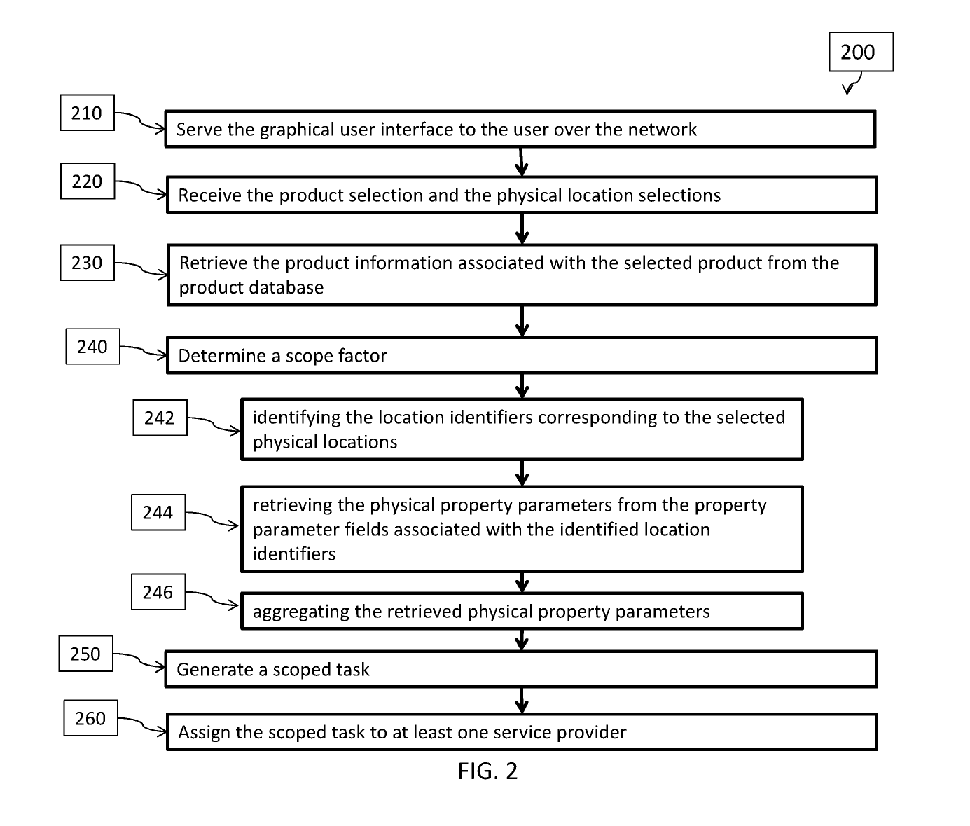

Referring to FIG. 2, a process employed by an embodiment of the server 130 includes serving the graphical user interface 210, receiving the product selection 220, determining a scope factor 230, retrieving the product information 240, generating a scoped task 250, and assigning the scoped task 260. Although the steps of FIG. 2 are described primarily with respect to FIGS. 1 and 3, one of skill in the art will understand that other computer architectures may be used. Additionally, one of ordinary skill in the art would recognize that one or more steps may be performed in a different order, repeated, modified, and/or omitted without deviating from the scope and spirit of the present invention.

In step 210, a graphical user interface is served to a user over a network. The server 130 may utilize a user's and/or customer's computer to serve, through the network 140, the graphical user interface 120. The network 140 may also enable the server 130 to retrieve and/or store information on a memory 110 that is stored in a separate location from the server 130.

In step 220, a product selection and a physical location selection are received. The user may input the product selection and/or physical location selection into the graphical user interface 120 to transmit such selections to the server 130 by way of the network 140. The user may provide additional inputs to server 130 by way of network 140, such as descriptions relating to the scope of the task, notes to be recorded with the assigned task, notes to be transmitted to the assigned service provider, desired parameters relating to the selected product or product information, etc.

In step 230, the product information associated with the selected product is retrieved from a product database. The server 130 may retrieve one or more products and associated product information using the product identifier. Additionally and/or alternatively, the server 130 may be configured to receive one or more characteristics of a product selected by the user that is not stored by the memory 110. The server 130 may be configured to utilize one or more inputted characteristics of an unstored product (i.e. a product not stored in the memory) to retrieve a product stored in the memory 110 that has product information that is similar and/or comparable to the inputted characteristics of the unstored product. In one embodiment, the server 130 is configured to map the selected characteristics of the unstored product to the product information associated with products of the product database 114. One of ordinary skill in the art would understand how to write and use suitable programming based on the functionality of the mapping disclosed herein.

In step 240, a scope factor is determined, e.g., by identifying the location identifiers corresponding to the selected physical locations, retrieving the physical property parameters from the property parameter fields associated with the identified location identifiers, and aggregating the retrieved physical property parameters. Sub-steps 242-246 illustrate one technique for determining a scope factor.

In sub-step 242, location identifiers corresponding to select physical locations are identified. The server 130 may identify location identifiers corresponding to the selected physical locations. The identification of location identifiers may be solely based on the user's selection of one or more of the plurality of physical locations. As discussed herein, the server 130 may identify one or more location identifiers corresponding to a plurality of physical locations based on the user's selection of a single physical location and/or selection of a group of cataloged physical locations.

In sub-step 244, physical property parameters are retrieved from property parameters fields associated with the identified location identifiers. The server 130 may retrieve the physical property parameters from the property parameter fields associated with the identified location identifiers. Additionally or alternatively, the server 130 may be configured to recommend a selection of one or more physical locations based on the user's input of at least one physical location and/or location identifier. For example, a user's input of a single physical location may retrieve a plurality of physical locations based on the selected physical location being cataloged into a group. In one embodiment, the user's selection of a physical location retrieves every physical location having the same or substantially the same store layout, which is presented as a recommendation for further selection and/or as automatically selected physical locations that may be deselected by the user.

In sub-step 246, the retrieved physical property parameters are aggregated. Server 130 may aggregate the retrieved physical property parameters. The server 130 may aggregate all of the physical property parameters and/or only the relevant physical property parameters. The server 130 may determine which physical property parameters are relevant based on the user's selection of one or more of the plurality of products. For example, the server 130 may determine that only the physical property parameters relating to bathrooms of the physical locations are relevant based on the user's selection of a toilet as the selected product. Thus, in this example, the server 130 may aggregate all physical property parameters relating to bathrooms for the selected physical locations. In one embodiment, the server 130 determines relevant property parameters based on the user's selection of one or more products by identifying the category of such selected products. In another embodiment, the server 130 determines the relevant physical property parameters based on the user's input of a category relating to the selected products and/or input of relevant physical property parameters for the task.

The server 130 may use the scope factor to determine the quantity of the products and/or services for completing the task. Additionally and/or alternatively, the server 130 may use the scope factor to determine the geographic locations of the task.

In step 250, a scoped task is generated. The server 130 may generate a scoped task by combining the scope factor with the product information of the selected products. For example, the server 130 may determine a scoped task by combining the aggregated relevant property parameters with the selected products. In one embodiment, the server 130 matches the product information of the selected products to the physical property parameters of the selected physical locations to determine the total number of products required to complete the task.

The server 130 may generate a scoped task that includes a scaled cost factor. The server 130 may determine the scaled cost factor by applying a geographic regional multiplier based on a geographic region of the selected physical location using the location identifier. The geographic regional multiplier incorporates differences in price/cost based on the region the product is to be completed or purchased. The geographic regional multiplier may also incorporate foreign exchange rates. The geographic region of the location identifier may be determined based on a zip code associated with each selected physical location. In one embodiment, the geographical region multiplier is determined based on the user selecting one or more regions, e.g., Western coast of U.S., Midwest of U.S., Southern U.S., Northeastern U.S., Central U.S., etc.

The computer architecture 100 may be configured to produce standardized tasks based the scoped factor and the scoped task. For example, the scoped factor enables the server 130 to produce a scoped task that is consistent for a selected product, which varies depending on the physical location parameters associated with selected physical locations. Accordingly, in one embodiment, computer architecture 100 is able to scale the scoped task by a defined amount based on the scope factor each time that physical location is selected for a task that relies on those physical property parameters. Additionally and/or alternatively, the standardization of the scoped task enables the server 130 to assign the scoped task to two or more service providers without the cost to the user for the scoped task increasing and/or while ensuring that the service providers provide the same product.

In step 260, the scoped tasks are assigned to at least one service provider. The server 130 may assign the scoped task to at least one service provider. The computer architecture 100 may include a service provider database configured to store a plurality of service providers and the server 130 assigns the scoped task automatically to at least one service providers in the service provider database. However, in one embodiment, the server 130 may recommend assigning the scoped task to the at least one service provider, whereby the user and/or the service provider are required to approve the assignment of the scoped task prior to the server 130 assigning the scoped task. The server 130 may assign the scoped task to at least one service provider based on the cost of the service provider, the quality of the service provider, and/or the ability for the service provider to handle the entirety or a portion of the scoped task.

Additionally, the server 130 may be configured to generate a total project scope. The total project scope refers to the entirety of the project if the user wants the scoped task to occur multiple times or over a period of time. The total project scope may be determined by combining the scoped task(s) and a quantity selection inputted by the user. The total project scope may also include a temporal selection. In one embodiment, the quantity selection and temporal selection are received by server 130 by way of the user inputting such selections into the graphical user interface 120.

The server 130 may also generate a real-time total cost associated with the total project scope. For example, the total cost may correspond to the quantity of scoped tasks not yet completed and/or the portion of the total project scope not yet completed. In one embodiment, the server 130 associates the quantity selection to the temporal selection and generates a real-time total cost for the total project scope by reducing the total project scope by a quantity number based on an amount of time. In another embodiment, the server 130 generates a real-time total cost by reducing the total project scope by a quantity number of assigned scoped tasks. Yet, in a further embodiment, the server 130 generates a real-time total cost of the total project scope by combining a number of unassigned scoped tasks and/or the cost of the uncompleted portion(s) of the scoped task.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A computer architecture for assigning tasks to service providers, the computer architecture comprising:
a location database including location information for a plurality of users, each user having one or more physical locations, the location database having a location identifier field configured to store a location identifier corresponding to each physical location and property parameter fields associated with the location identifiers configured to store physical property parameters;
a product database for a plurality of products, the product database having a product identifier field configured to store a product identifier and associated product information fields configured to store product information corresponding to each of the plurality of product;
a graphical user interface for presentation to a user over a network, the graphical user interface configured to receive a selection of a product from the plurality of products and selections of a physical from the plurality of physical locations;
a server configured to:
serve the graphical user interface to the user over the network;
receive the product selection and the physical location selections;
determine a scope factor by identifying the location identifiers corresponding to the selected physical locations, retrieving the physical property parameters from the property parameter fields associated with the identified location identifiers, and aggregating the retrieved physical property parameters;
retrieve the product information associated with the selected product from the product database;
generate a scoped task by combining the scope factor with the product information; and
assign the scoped task to at least one service provider.

2. The computer architecture of claim 1, further comprising a service provider database configured to store a plurality of service providers and wherein the server assigns the scoped task automatically to at least one service providers in the service provider database.

3. The computer architecture of claim 1, wherein the scoped task includes a scaled cost factor and wherein the scaled cost factor is determined by applying a geographic regional multiplier based on a geographic region of the selected physical location using the location identifier.

4. The computer architecture of claim 3, wherein the geographic region of the location identifier is determined based on a zip code associated with each selected physical location.

5. The computer architecture of claim 1, wherein the graphical user interface is configured to receive one or more characteristics of the selected product, and the server is configured to map the selected characteristics of the selected product to the product information associated with products of the product database.

6. The computer architecture of claim 1,
wherein the graphical user interface is configured to receive a temporal selection and a quantity selection for the scoped tasks, and
wherein the server receives the temporal selection and the quantity selection, and generates a total project scope by combining the scoped tasks and the quantity selection.

7. The computer architecture of claim 6, wherein the server associates the quantity selection to the temporal selection and generates a real-time total cost for the total project scope by reducing the total project scope by a quantity number based on an amount of time.

8. The computer architecture of claim 6, wherein the server generates a real-time total cost by reducing the total project scope by a quantity number of assigned scoped tasks.

9. The computer architecture of claim 6, wherein the server generates a real-time total cost of the total project scope by combining a number of unassigned scoped tasks.
